(19) United States
(12) Patent Application Publication
(10) Pub. No.: US 2015/0051306 A1
(43) Pub. Date: Feb. 19, 2015

(54) METHOD FOR PREPARING A COFFEE POLYOL AND COMPOSITIONS AND MATERIALS CONTAINING THE SAME

(71) Applicant: SINGTEX INDUSTRIAL CO., LTD., New Taipei City (TW)

(72) Inventors: Kuo-Chin CHEN, New Taipei City (TW); Li-Hsun CHANG, New Taipei City (TW); Szu-Min CHIAO, New Taipei City (TW); Lai-Hung WAN, New Taipei City (TW)

(21) Appl. No.: 14/531,792

(22) Filed: Nov. 3, 2014

Related U.S. Application Data
(63) Continuation-in-part of application No. 13/678,019, filed on Nov. 15, 2012.
(60) Provisional application No. 61/560,464, filed on Nov. 16, 2011.

(51) Int. Cl. C08G 18/36; C08J 3/22; C08G 18/08; D01F 6/70; C08J 5/18; C09D 175/04

(52) U.S. Cl. CPC C08G 18/36; C08J 5/18; C09D 175/04; C08G 18/14; D01F 6/70; C08J 3/22; C08J 2375/04
USPC 521/117; 554/9; 554/11; 524/590; 524/9; 524/448; 524/10; 524/447; 524/451; 528/85

(57) ABSTRACT

A method for preparing a coffee polyol includes: (a) extracting coffee oil from coffee grounds; (b) modifying the coffee oil to obtain an epoxidized coffee oil; and (c) reacting an alcohol with the epoxidized coffee oil to obtain a coffee polyol. A polyurethane dispersive solution is prepared from a prepolymer composition that includes: a coffee polyol prepared from the abovementioned method; an isocyanate; and a solvent. A foam-based material is made from a foaming composition that includes a coffee polyol prepared from the abovementioned method. A polyurethane material is made from a polyurethane composition that includes a coffee polyol prepared from the abovementioned method.

### CROSS-REFERENCE TO RELATED APPLICATION

This application is a continuation-in-part (CIP) of U.S. patent application Ser. No. 13/678019, filed on Nov. 15, 2012, which claims priority of U.S. provisional Application No. 61/560464, filed on Nov. 16, 2011, the entire disclosure of each of which is incorporated herein by reference.

### FIELD OF THE INVENTION

This invention relates to a method for preparing a coffee polyol, and a polyurethane dispersive solution, a foam-based material, a polyurethane material, and an elastic polyurethane fiber that are prepared from the coffee polyol.

### BACKGROUND OF THE INVENTION

Due to environmental concerns and dramatically increased cost of petroleum feedstocks, many research efforts regarding finding renewable resources, that are able to reduce the use of fossil fuels, have been done. Bio-based materials which contain raw materials derived from biological resources (also called biomass) are now considered “green” and “eco-friendly”. Various species of biomass have been proposed, including natural plants (such as corn, palm, soy, etc.), and reuse waste of natural plants (such as coffee grounds, rice straw, waste wood, etc.).

Coffee grounds have been considered as useless, and are normally discarded as waste by soil burying. Taiwanese Patent No. 1338729 discloses a yarn containing coffee grounds. Coffee grounds contain coffee oil. In order to improve textile yield, some organic components (mainly coffee oil) are required to be removed from coffee grounds before mixing the coffee grounds into a master batch. The coffee oil removed from the coffee grounds is normally discarded as waste.

Conventionally, polyurethane (PU) is made from petro polyol derived from petroleum oil. In recent years, polyol derived from corn and soybean have been proposed to replace petro polyols in the preparation of PU. For example, U.S. Pat. Nos. 7,786,239, 7,674,925, 7,696,370 or 6,433,121 disclose methods for producing polyol from soy oil.

However, the rise of global food prices and worries of shortage of corn and soybean have discouraged industries from using corn and soybean as a raw material for chemical products. Hence, there is a need to find a new source that is economically acceptable and that contains oil with properties suitable for making polyol.

### SUMMARY OF THE INVENTION

Therefore, the object of the present invention is to provide a method for preparing a coffee polyol from coffee oil.

According to a first aspect of the present invention, there is provided a method for preparing a coffee polyol. The method comprises: (a) extracting coffee oil from coffee grounds; (b) modifying the coffee oil to obtain an epoxidized coffee oil; and (c) reacting an alcohol with the epoxidized coffee oil to obtain a coffee polyol.

According to a second aspect of this invention, there is provided a polyurethane dispersive solution, which is prepared from a prepolymer composition that comprises the coffee polyol prepared from the method of this invention, an isocyanate, and a first solvent.

According to a third aspect of this invention, there is provided a functional film made from the polyurethane dispersive solution of this invention.

According to a fourth aspect of this invention, there is provided a printing paste that comprises the polyurethane dispersive solution of this invention.

According to a fifth aspect of this invention, there is provided a foam-based material prepared from a foaming composition that comprises: the coffee polyol prepared from the method of this invention; a petro polyol; an isocyanate; a filler; a foam stabilizer; a catalyst which is capable of catalyzing polymerization among the isocyanate, the coffee polyol and the petro polyol; and a foaming agent.

According to a sixth aspect of this invention, there is provided a polyurethane material made from a polyurethane composition that comprises: the coffee polyol prepared from the method of this invention; a petro polyol; an isocyanate; a surfactant; and a catalyst which is capable of catalyzing polymerization among the isocyanate, the coffee polyol and the petro polyol.

According to a seventh aspect of this invention, there is provided an elastic polyurethane fiber made from the polyurethane material of this invention using fiber spinning techniques.

According to an eighth aspect of this invention, there is provided a polyurethane masterbatch prepared from a mixture containing the polyurethane material of this invention and a colorant additive that includes a dye or a pigment.

### BRIEF DESCRIPTION OF THE DRAWINGS

In drawings which illustrate embodiments of the invention,

FIG. 1 is a SEM sectional diagram (magnification: 300×) illustrating foam-coated textiles of Example 4;

FIG. 2 is a SEM sectional diagram (magnification: 300×) illustrating functional textiles of Example 5;

FIG. 3 is a SEM diagram (magnification: 400×) illustrating the surface morphology of a printing paste of a functional textile of Example 6; and

FIG. 4 is a SEM diagram (magnification: 100×) illustrating the surface morphology of a foam-based material of Example 7.

### DETAILED DESCRIPTION OF THE EMBODIMENTS

The present invention relates to a method of preparing a coffee polyol and applications of the coffee polyol for making a polyurethane dispersive solution, a functional film, a printing paste, a foam-based material, a polyurethane material, an elastic polyurethane fiber, and a polyurethane masterbatch.

The embodiment of the method for preparing a coffee polyol of this invention comprises: (a) extracting coffee oil from coffee grounds; (b) modifying the coffee oil to obtain an epoxidized coffee oil; and (c) reacting an alcohol with the epoxidized coffee oil to obtain a coffee polyol.

The coffee grounds used in the extraction may be baked or not baked. The extraction of the coffee oil from the coffee grounds can be conducted using a conventional method, such as distillation, supercritical carbon dioxide extraction, resin extraction, and solvent extraction.

Preferably, modification of the coffee oil in step (b) is conducted by thermally treating the coffee oil with a modifying solution that includes an acid solution, peroxy acid, water, and hydrogen peroxide. The acid solution is selected from the group consisting of sulfuric acid solution, oxalate solution (e.g., oxalic acid solution), and glacial acetic acid solution. The peroxy acid is selected from the group consisting of peracetic acid and performic acid.

Preferably, the alcohol employed in step (c) is selected from the group consisting of methanol, ethanol, glycol, and combinations thereof.

Preferably, the coffee polyol is a polyol of a fatty acid. The fatty acid is selected from the group consisting of palmitic acid, stearic acid, oleic acid, linoleic acid, linolenic acid, arachidic acid, and combinations thereof.

The polyurethane dispersive solution is prepared from a prepolymer composition that comprises the coffee polyol, an isocyanate, and a first solvent. The first solvent may be an organic solvent or water, and the polyurethane dispersive solution may be classified as water-based or organic solvent-based accordingly.

Examples of the isocyanate include, but are not limited to, aromatic diisocyanates, such as diphenylmethane diisocyanate (MDI), toluene diisocyanate (TDI), 1,4-diisocyanatobenzene, xylylene diisocyanate, and 2,6-naphthalene diisocyanate, and aliphatic diisocyanates, such as isophorone diisocyanate.

The organic solvent is preferably selected from dimethylformamide (DMF), toluene, methyl ethyl ketone (MEK), dimethylacetamide (DMAC), acetone, and combinations thereof.

Preferably, the prepolymer composition further includes a petro polyol (a polyol derived from petroleum). Examples of the petro polyol include, but are not limited to, polyethylene glycol, modified polyethylene glycol, polypropylene glycol, polytrimethylene ether glycol, and polytetramethylene ether glycol (PTMG). More preferably, the petro polyol has a weight average molecular weight ranging from 600 to 20000.

Preferably, the petro polyol is in an amount ranging from 100 to 200 parts by weight and the isocyanate is in an amount ranging from 50 to 150 parts by weight based on 100 parts by weight of the coffee polyol.

Preferably, the prepolymer composition further includes an emulsifier, a neutralizer and a chain extender.

Examples of the emulsifier include, but are not limited to, dimethylol propionic acid (DMPA), the coffee polyol, coffee oil, and coffee grounds.

Examples of the neutralizer include, but are not limited to, sodium hydroxide aqueous solution, potassium hydroxide aqueous solution, and triethylamine (TEA) aqueous solution.

Examples of the chain extender include, but are not limited to, 1,4 butanediol solution, ethylenediamine (EDA) solution, benzenediamine solution, and amino ethyl ethanol amine (AEEA).

In the embodiment, the method of preparing the polyurethane dispersive solution from the prepolymer composition includes: (i) polymerizing a mixture of the coffee polyol, the petro polyol and the isocyanate in the presence of the first solvent to obtain a prepolymer solution; (ii) adding an emulsifier to the prepolymer solution for emulsification, followed by adding a neutralizer for neutralization; and (iii) adding a chain extender to the prepolymer solution to obtain the polyurethane dispersive solution.

In making the functional film, the polyurethane dispersive solution (water-based type) is mixed with a crosslinking agent, a foaming agent and a foam stabilizer so as to form a film-forming solution, followed by foam coating the film-forming solution on a substrate. Examples of the substrate include, but are not limited to, a fibrous layer, a release paper and a polyester film. The fibrous layer may be selected from the group consisting of a woven fabric, a knitted fabric and a non-woven fabric.

Preferably, the crosslinking agent is selected from the group consisting of melamine, poly(melamine-co-formaldehyde), trimethylolpropane tris(2-methyl-1-aziridinepropionate, and poly(melamine-co-formaldehyde) isobutylated and water dispersible polyisocyanate.

Preferably, the foaming agent is purchased from KLK OLEO company, having catalog no.: 70C.

Preferably, the foam stabilizer is stearyldiethanolamine.

The printing paste is made from a composition comprising the polyurethane dispersive solution (organic solvent-based type), a filler and a second solvent. The filler is in an amount ranging from 10 to 30 parts by weight and the second solvent is in an amount ranging from 60 to 100 parts by weight based on 100 parts by weight of the polyurethane dispersive solution.

Preferably, the filler is selected from coffee powder, diatomite, zeolite, eggshell, sepiolite, kaolin, carbon black, active carbon, talc, jade, tea plant, and combinations thereof. More preferably, the filler is coffee powder.

Preferably, the coffee powder is selected from the group consisting of coffee residue powder (formed by removing organic components from the coffee ground), carbonized coffee powder, and a combination thereof.

The second solvent is useful for adjusting the viscosity of the printing paste. Preferably, the second solvent is selected from the group consisting of butanone (methyl ethyl ketone, MEK), acetone, ethyl acetate, toluene, DMF, DMAC, and combinations thereof. The foam-based material is prepared from a foaming composition that comprises: the coffee polyol; a petro polyol; an isocyanate; a chain extender; a glycerine; a surfactant; a catalyst, which is capable of catalyzing polymerization among the isocyanate, the coffee polyol and the petropolyol; and a foaming agent.

Preferably, the foaming composition further comprising a filler. More preferably, the filler is selected from coffee powder, diatomite, zeolite, eggshell, sepiolite, kaolin, carbon black, active carbon, talc, jade, tea plant, and combinations thereof. The coffee powder is selected from the group consisting of coffee residue powder (formed by removing organic components from coffee grounds), carbonized coffee powder, and the combination thereof. Preferably, the petro polyol is in an amount ranging from 500 to 700 parts by weight, the surfactant is in an amount ranging from 5 to 10 parts by weight, the glycerine is in an amount ranging from 5 to 10 parts by weight, the catalyst is in an amount ranging from 0.5 to 1 part by weight, the chain extender is in amount ranging from 0.2 to 1 part by weight, and the isocyanate is in an amount ranging from 300 to 400 parts by weight, and the filler is in an amount ranging from 200 to 300 parts by weight based on 100 parts by weight of the coffee polyol.

Examples of the petro polyol include, but are not limited to, polyethylene glycol, modified polyethylene glycol, polypropylene glycol, polytrimethylene ether glycol, and polytetramethylene ether glycol (PTMG). Preferably, the petro polyol has a weight average molecular weight ranging from 600 to 20000, more preferably from 1000 to 3000.

The isocyanate can be an aromatic isocyanate or an alicyclic isocyanate, more preferably, an aromatic diisocyanate or an alicyclic diisocyanate. Examples of the aromatic diisocyanate include, but are not limited to, diphenylmethane diisocyanate (MDI), toluene diisocyanate (TDI), 1,4-diisocyanatobenzene, xylylene diisocyanate, 2,6-naphthalene diisocyanate, octahydro-1,5-naphthalene diisocyanate, and combinations thereof.

Examples of the alicyclic diisocyanate include methylenebis(cyclohexylisocyanate), isophorone diisocyanate, methylcyclo-hexane-2,4-diisocyanate, methylcyclohexane-2,6-diisocyanate, cyclohexane-1,4-diisocyanate, hexahydroxylylene diisocyanate, hexahydrotolylene diisocyanate, and combinations thereof. The aliphatic diisocyanate is useful for prevention of yellowing of polyurethane materials made from the foaming composition.

A non-limiting example of the surfactant is SH192 (available from Toray Dow Corning).

Examples of the catalyst include, but are not limited to, dibutyltin dilaurate, bismuth 2-ethylhexanoate, and the combination thereof.

Examples of the foaming agent include, but are not limited to, water, methylene chloride and the combination thereof.

The polyurethane material is made from a polyurethane composition that comprises the coffee polyol, a petro polyol, an isocyanate, a surfactant, and a catalyst, which is capable of catalyzing polymerization among the isocyanate, the coffee polyol and the petro polyol.

Examples of the petro polyol, the isocyanate, the surfactant, and the catalyst included in the polyurethane composition are similar to those in the aforementioned foaming composition of the foam-based material.

Preferably, the polyurethane composition may further comprise a filler selected from the group consisting of coffee powder, diatomite, zeolite, eggshell, sepiolite, kaolin, carbon black, active carbon, talc, jade, tea plant, and combinations thereof.

The elastic polyurethane fiber is made from the aforementioned polyurethane material using a conventional fiber spinning technique.

The polyurethane masterbatch is prepared from a mixture containing the aforementioned polyurethane material and a colorant additive that includes a dye or a pigment.

The merits of the method for preparing a coffee polyol of this invention will become apparent with reference to the following Examples and Comparative

Example. The method of this invention should not be restricted to the following Examples.

### EXAMPLES

### Example 1 (EX1)

### Preparation of Coffee Polyol

28 kg of coffee grounds were dried at 80° C. under stirring for 2 hours to obtain 14 kg of dry coffee grounds. The dry coffee grounds were divided into two equal parts (i.e., 7 kg per part). Each part was evenly placed into a 20 L extraction tank along with 2 kg of glass beads (particle size: 5 mm), followed by extracting coffee oil therefrom using supercritical carbon dioxide. The flow rate of carbon dioxide was 463 g/min, and the pressure and temperature in the extraction tank were 5075 psig and 65° C., respectively. The extraction lasted for 400 minutes to obtain 1.68 kg of coffee oil. The process was repeated so as to collect a desired amount of the coffee oil.

20 kg of the coffee oil thus collected, 1.4 kg of glacial acetic acid, 2 kg of pure water, 500 g of acetic acid and a catalyst including 120 g of sulfuric acid were mixed evenly in a 100 kg reaction tank. After heating the mixture to 70° C., 12 kg of hydrogen peroxide (having a concentration of 35%) was slowly added into the reaction tank for a time period of within 3 hours. After reaction for 3.5 hours, the mixture was washed six times with 20 kg of pure water and was then separated into oil and water phase. The oil phase was taken from the water phase, and was mixed with 11 kg of methanol (with a concentration of 95%). After reflux for 8 hours at 68° C., the methanol was removed therefrom through a vacuum system so as to obtain about 20 kg of coffee polyol.

### Example 2 (EX2)

### Preparation of Water-Based Polyurethane Dispersive Solution

34 g of dehydrated coffee polyol, 145 g of poly (tetramethylene ether) glycol (PTMG, Mw: 2000), 45 g of poly propylene glycol (PPG) and 18 g of dimethylol propionic acid were mixed in a flask. 90 g of isophorone diisocyanate (IPDI) was subsequently and slowly added into the mixture to initiate prepolymerization so as to produce a isocynate terminated prepolymer. The reaction was monitored by measuring the NCO content of the isocynate terminated prepolymer under 85° C. using a titration method of ASTM-D1368. When the NCO content of the isocynate terminated prepolymer was less than 90% of the theoretical value, the reaction temperature was cooled down to 60° C., and 13.5 g of triethylamine (TEA) was added into the reaction mixture to neutralize the reaction mixture. After 10 minutes, the neutralization was completed, and the reaction mixture was cooled down to room temperature. 77 g of the coffee polyol was added to the reaction mixture for emulsification to obtain a prepolymer. 485 g of deionized water was then added into the reaction mixture for phase transition. After completion of the phase transition, an aqueous solution containing 11.10 g amino ethyl ethanol amine (AEEA) and 10 g of pure water was slowly added into the reaction mixture to obtain a milky white emulsion. The amino ethyl ethanol amine was reacted to the NCO groups of the prepolymer and extended the chain length of the prepolymer.

### Example 3 (EX3)

### Preparation of Organic Solvent-Based Polyurethane Dispersive Solution

34 g of dehydrated coffee polyol, 195 g of PTMG, and 1000 g of a solvent containing dimethyl fumarate (DMF), toluene and methyl ethyl ketone (MEK) were mixed in a flask (40 wt % of DMF, 40 wt % of tolulene, and 20 wt % of MEK). 90 g of IPDI was slowly added to the mixture to initiate prepolymerization so as to produce isocynate terminated prepolymer. The reaction was monitored by measuring the NCO content of the isocynate terminated prepolymer under 85° C. using a titration method of ASTM-D1368. When the NCO content of the isocynate terminated prepolymer was less than 90% of the theoretical value, 77 g of coffee polyol was slowly added to the reaction mixture for emulsification, and 10.17 g of amino ethyl ethanol amine (AEEA) in 20 g of dimethylacetamide (DMAC) was slowly added to the reaction mixture after the emulsification so as to obtain the organic solvent-based polyurethane dispersive solution.

### Example 4 (EX4)

### Preparation of Functional Film (Foam-Coated Textile)

100 g of the water-based polyurethane dispersive solution prepared from Example 2, 0.5 g of foaming agent (purchased from KLK OLEO company, catalog no.: 70C), and 3 g of trimethylolpropane tris(2-methyl-1-aziridinepropionate serving as a crosslinking agent were mixed in a mixer under rapid stirring for 5 to 10 minutes. 3 g of stearyldiethanolamine serving as foam stabilizer was further added to the mixture under rapid stirring for 2 to 3 minutes. The mixture was subjected to foaming (blow ratio was 3:1 to 6:1), to obtain a foam. The foam thus formed was evenly coated on a fabric made by coffee yarn (prepared according to the method disclosed in TW Patent Application Publication No. 200918695). The coated fabric was predried under 90° C. for 1.5 minutes and was baked under 150° C. for 1 minute to obtain a foam-coated textile.

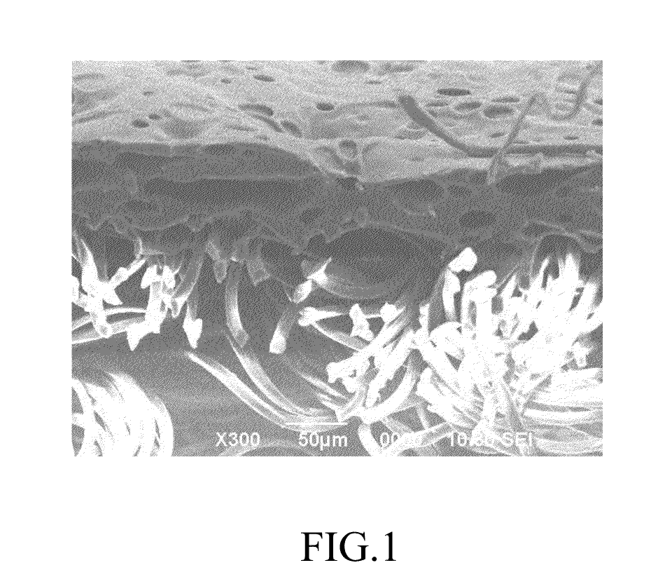

FIG. 1 is a SEM diagram (magnification was 300×) showing a cross-section of the foam-coated textile.

### Example 5 (EX5)

### Preparation of Functional Textile

100 g of the organic solvent-based polyurethane dispersive solution prepared from Example 3 and 3 g of trimethylolpropane tris(2-methyl-1-aziridinepropionate) serving as a crosslinking agent were mixed in a mixer under rapid stirring for 5 to 10 minutes. 3 g of a polyether polyurethane type thickening agent was added into the mixture under rapid stirring for 2 to 3 minutes. The mixture thus obtained was evenly coated on a fabric made by coffee yarn (prepared according to the method disclosed in TW Patent Application Publication No. 200918695) to obtain a coated fabric with a mixture layer. The coated fabric was subjected to a phase transition under 80° C. in a deionized water bath, followed by predrying under 90° C. for 1.5 minutes and baking under 150° C. A printing paste (prepared according to the method of preparing a polyurethane dispersive solution disclosed in TW Patent Application Publication No. 200918695) was further coated on the mixture layer of the coated fabric to obtain a functional textile.

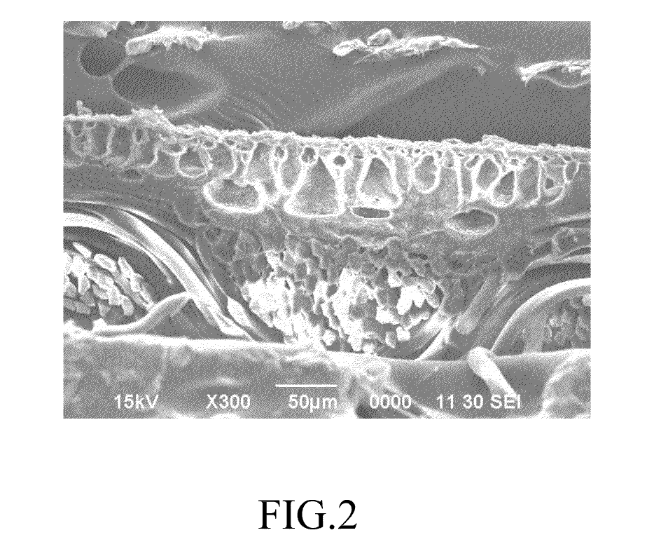

FIG. 2 is a SEM diagram (magnification was 300×) showing a cross section of the functional textile.

### Example 6 (EX6)

### Preparation of Functional Textile

100 g of solvent-based polyurethane dispersive solution prepared from Example 3 and 3 g of trimethylolpropane tris(2-methyl-1-aziridinepropionate) serving as a crosslinking agent were mixed in a mixer under rapid stirring for 5 to 10 minutes. 3 g of a polyether polyurethane type thickening agent was added into the mixture under rapid stirring for 2 to 3 minutes. The mixture thus obtained was evenly coated on a fabric made by coffee yarn (prepared according to the method disclosed in TW Patent Application Publication No. 200918695) to obtain a coated fabric with a mixture layer. The coated fabric was subjected to a phase transition under 80° C. in a deionized water bath, followed by predrying under 90° C. for 1.5 minutes and baking under 150° C. 100 g of the organic solvent-based polyurethane dispersive solution prepared from Example 3, 80 g of butanone (MEK) and 20 g of coffee residue powder were sequentially mixed in a mixer under rapid stirring (100 rpm) to obtain a printing paste. The printing paste thus formed was further coated on the mixture layer of the coated fabric to obtain a functional textile.

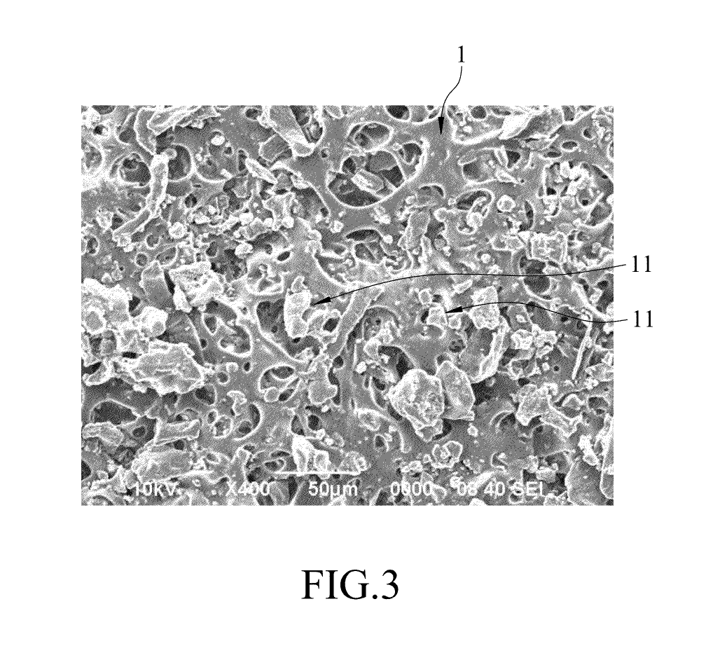

FIG. 3 is a SEM diagram (magnification was 400×) illustrating the surface morphology of the functional textile with the printing paste 1, and showing the coffee residue powder 11 employed in the printing paste 1.

### Example 7 (EX7)

### Preparation of the Foam-Based Material

11 g of the coffee polyol and 72 g of polypropylene glycol (purchased from Dow Chemical company, catalog no.: polyol 3000A, M. W.:3000) were mixed in a container, followed by sequentially adding 1 g of surfactant (catalog no. :SH192 purchased from Toray Dow Corning), g of glycerine, 0.1 g of dibutyltin dilaurate (purchased from TCI, catalog no. :T12) serving as the catalyst, 0.03 g of 1,4-diazabicyclo[2.2.2] octane solution (purchased from Huntsman, catalog no.:33LV) serving as the chain extender, and 3.6 g of water into the mixture under stirring (50 rpm) until the mixture was uniformly mixed. 38 g of toluene diisocyanate (TDI) was added into the mixture under stirring (1200 rpm) for 5 to 8 seconds. After mixing, the mixture was immediately poured into a mold for foaming.

### Example 8 (EX8)

### Preparation of the Foam-Based Material with Coffee Residue Powders

The procedures and conditions in preparing the foam-based material of Example 8 were similar to those of Example 7 except that 28 g of coffee residue powder was added into the mixture before addition of toluene diisocyanate (TDI).

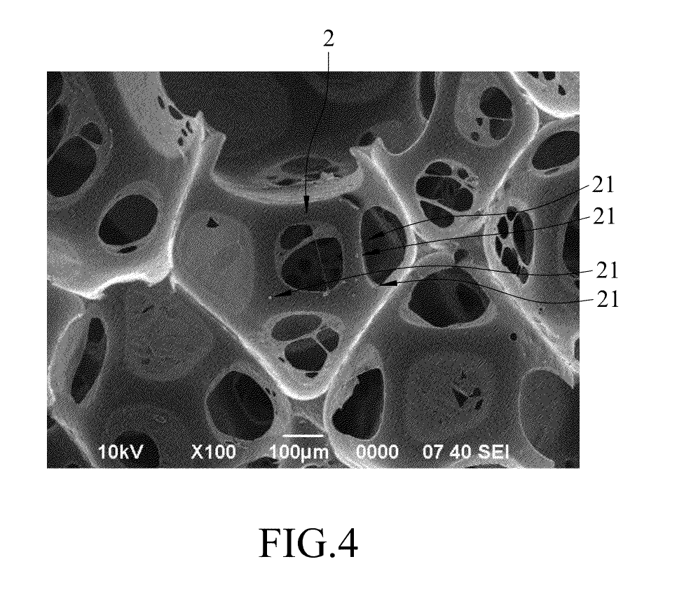

FIG. 4 is a SEM diagram (magnification was 100×) illustrating the surface morphology of the foam-based material of Example 8. The SEM diagram illustrates the configuration of the coffee residue powder 21 employed in the foam-based material 2.

### Comparative Example 1 (CE1)

### Preparation of a Foam-Based Material

The procedures and conditions in preparing the foam-based material of Comparative Example 1 were similar to those of Example 7 except that the coffee polyol was not used in Comparative Example 1.

### Performance Test

### Tensile Strength

The tensile strength of the foam-based materials of Examples 7 and 8 and Comparative Example 1, which were measured according to ASTM D3574 standard method, are 0.88, 0.94, and 0.58 kg/cm², respectively.

The present invention has advantages in that the transformation of the coffee oil into the coffee polyol permits reduction of the amount of coffee waste, which reduces the influence of the coffee waste on the environment, and that the coffee polyol derived from the coffee oil is suitable for making materials, such as the polyurethane dispersive solution, the functional film, the printing paste, the foam-based material, the polyurethane material, the elastic polyurethane fiber, and the polyurethane masterbatch.

With the invention thus explained, it is apparent that various modifications and variations can be made without departing from the spirit of the present invention. It is therefore intended that the invention be limited only as recited in the appended claims.

What is claimed is:

1. A method for preparing a coffee polyol, comprising:
(a) extracting coffee oil from coffee grounds;
(b) modifying the coffee oil to obtain an epoxidized coffee oil; and
(c) reacting an alcohol with the epoxidized coffee oil to obtain a coffee polyol.

2. The method of claim 1, wherein modification of the coffee oil in step (b) is conducted by thermally treating the coffee oil with a modifying solution, the modifying solution including an acid solution, peroxy acid, water, and hydrogen peroxide, the acid solution being selected from the group consisting of sulfuric acid solution, oxalate solution, and glacial acetic acid solution.

3. The method of claim 1, wherein the alcohol employed in step (c) is selected from the group consisting of methanol, ethanol, glycol, and combinations thereof.

4. The method of claim 1, wherein the coffee polyol is a polyol of a fatty acid, the fatty acid being selected from palmitic acid, stearic acid, oleic acid, linoleic acid, linolenic acid, arachidic acid, and combinations thereof.

5. A polyurethane dispersive solution prepared from a prepolymer composition comprising:
a coffee polyol prepared from the method as claimed in claim 1;
an isocyanate; and
a first solvent.

6. The polyurethane dispersive solution of claim 5, wherein said prepolymer composition further comprises an emulsifier, a neutralizer and a chain extender.

7. The polyurethane dispersive solution of claim 5, wherein said prepolymer composition further comprises petro polyol.

8. A functional film made from a polyurethane dispersive solution as claimed in claim 5.

9. A printing paste made from a composition comprising a polyurethane dispersive solution as claimed in claim 5.

10. The printing paste of claim 9, wherein said composition comprises a filler and a second solvent, wherein said filler is selected from coffee powder, diatomite, zeolite, eggshell, sepiolite, kaolin, carbon black, active carbon, talc, jade, tea plant, and combinations thereof.

11. The printing paste of claim 10, wherein said coffee powder is selected from the group consisting of coffee residue powder, carbonized coffee powder, and a combination thereof.

12. A foam-based material prepared from a foaming composition comprising:
a coffee polyol prepared from the method as claimed in claim 1;
a petro polyol;
an isocyanate;
a chain extender;
a glycerin;
a surfactant;
a foam stabilizer;
a catalyst, which is capable of catalyzing polymerization among said isocyanate, said coffee polyol and said petro polyol; and
a foaming agent.

13. The foam-based material of claim 12, wherein said chain extender further comprising a filler.

14. The foam-based material of claim 13, wherein said petro polyol is in an amount ranging from 500 to 700 parts by weight, said surfactant is in an amount ranging from 5 to 10 parts by weight, said glycerine is in an amount ranging from 5 to 10 parts by weight, said catalyst is in an amount ranging from 0.5 to 1 part by weight, said chain extender is in amount ranging from 0.2 to 1 part by weight, said isocyanate is in an amount ranging from 300 to 400 parts by weight, and said filler is in an amount ranging from 200 to 300 parts by weight based on 100 parts by weight of said coffee polyol.

15. The foam-based material of claim 13, wherein said filler is selected from coffee powder, diatomite, zeolite, eggshell, sepiolite, kaolin, carbon black, active carbon, talc, jade, tea plant, and combinations thereof.

16. The foam-based material of claim 12, wherein said petro polyol has a weight average molecular weight ranging from 600 to 20000.

17. The foam-based material of claim 12, wherein said petro polyol is polypropylene glycol.

18. A polyurethane material made from a polyurethane composition that comprises:
a coffee polyol prepared from the method as claimed claim 1;
a petro polyol;
an isocyanate;
a surfactant; and
a catalyst, which is capable of catalyzing polymerization among said isocyanate, said coffee polyol and said petro polyol.

19. The polyurethane material of claim 18, wherein said polyurethane composition further comprises a filler selected from coffee powder, diatomite, zeolite, eggshell, sepiolite, kaolin, carbon black, active carbon, talc, jade, tea plant, and combinations thereof.

20. An elastic polyurethane fiber made from the polyurethane material as claimed in claim 18 using fiber spinning techniques.

21. A polyurethane master batch prepared from a mixture containing the polyurethane material as claimed in claim 18 and a colorant additive that includes a dye or a pigment.
